(19) United States
(12) Patent Application Publication
(10) Pub. No.: US 2011/0308748 A1
(43) Pub. Date: Dec. 22, 2011

(54) Stiffening Device and Blind Box Part Equipped with Such a Device

(75) Inventors: Mathieu BRIGNATZ, CHATEAUNEUF de GADAGNE (FR); Miguel LELEU, LES CARROZ (FR)

(73) Assignee: SOMFY SAS, CLUSES (FR)

(21) Appl. No.: 13/116,691

(22) Filed: May 26, 2011

(30) Foreign Application Priority Data
May 31, 2010 (FR) 10 54221

(51) Int. Cl. E06B 9/38

(52) U.S. Cl. 160/368.1

(57) ABSTRACT

This device (30) is used to stiffen a box part (10) for receiving a motor-drive device for operating a blind, the box part having a U section with an external surface (13) and an internal surface (14). This device is independent of the supporting means for the box part relative to a support structure and comprises a first contact element (31) intended to cooperate with at least a part of an external surface (13) of the box part; a second contact element (32) intended to cooperate with at least a part of an internal surface (14) of the box part, and tightening means (35) acting on the first contact element (31) and/or the second contact element (32), in a direction of convergence of this element and of the part of the surface of the box part (13, 14) with which it is intended to cooperate. A box part (10) equipped with such a device is stiffened in an axis (Y-Y′) perpendicular to its longitudinal axis (X-X′).

The invention relates to the field of solar protection blinds, and in particular venetian blinds with parallel, folding and orientable slats.

These venetian blinds can be operated via a motor-drive device, housed in a support box part, toward which the slats are folded back in a complete opening movement of the blind. The slats are in turn supported by cords or strips and the motor-drive device also manages the winding of the cords or strips in the box part.

The prior art abounds with motor-drive devices mounted in U-shaped box parts. In particular, many solutions have been described making it possible to mount a motor in a box part using elastomer supports avoiding the propagation of the vibrations of the motor to the box part, so as to reduce the noise associated with the motor-drive device when it is operating.

In particular, the document EP-A-1321623 describes elastomer supports added between the feet of a motor and the free flanges of the U shape of the box part, or positioned at the ends of a motor support ring. These are therefore used to absorb any vibrations transmitted towards the box part. It is also known from the same document to secure the box part with respect to the support structure, for example a wall or a ceiling from which the blind is suspended, by virtue of support hooks, clamping the box part. These hooks are provided with flexible tabs so as to be able to insert the U-shaped box part therein. Several hooks support the box part over its length.

The document DE-U-202007010766 describes a device for securing a motor inside a box part that does not require the use of a tool. The securing device notably comprises a cleat provided with folded flanges at its ends. These flanges are housed under the bent-back edges of the U-shaped box part. Through the intermediary of an eccentric lever, the cleat presses the motor into a cradle in the bottom of the box part and also makes it possible to press against the box part the ends of the motor support cradle. The document DE-U-202008002359 describes a similar device, for which the motor support cradle comprises shackles bearing on the bent-back edges of the box part. These shackles cooperate with a hook for securing the motor in the rail, this hook including holes into which the shackles of the cradle are fitted.

The document CH-A-691131 also describes a device for securing a motor inside a box part. The motor is equipped at its ends with elastomer elements, to avoid the propagation of noise. The securing device notably comprises a flange in two parts assembled by screws and axially and radially securing the motor and the elastomer elements.

The various documents of the art, although they describe the issues of noise and mechanical and elastic fixing of the motor, do not however make it possible to determine a solution to the problem of propagation of vibrations in the box part itself. In practice, the U-shape of the box part and its length are part of the reason why the box part itself is relatively flexible. Because of metallic materials used to manufacture certain components, the vibrations linked to the transmission of the movements of the blind can be propagated and amplified by the box part.

It is also known from NL-A-6,400,653 or U.S. Pat. No. 4,949,926 to use two-part consoles, comprising a support and a blocking member, to fix the rail of a blind on a support structure. By construction, such equipment must allow for the placement of the rail after the fixing of the support on a support structure, such as a ceiling or a wall. The blocking element is supported on this support, with pivoting capability as in NL-A-6,400,653, or capability for sliding against a spring as in U.S. Pat. No. 4,949,926. These movements require play, to the point that the edges of the box part may vibrate transversely, including after mounting on the consoles. Furthermore, vibrations may be propagated to the free edges of the box part, between two consoles, and the number of consoles used to fix the rail to the support structure cannot be increased without accordingly increasing the installation time.

The invention therefore proposes a device intended to stiffen the box part to reduce or prevent the problems described above.

To this end, the invention relates to a device for stiffening a box part of a motor-drive device for operating a blind, this box part having a U section with at least one external surface and at least one internal surface. This stiffening device is characterized in that it is independent of the supporting means of the box part relative to a support structure and in that it comprises:
a first contact element intended to cooperate with at least a part of the external surface of the box part;
a second contact element intended to cooperate with at least a part of the internal surface of the box part; and
tightening means acting on the first element and/or on the second contact element, in a direction of convergence of this element and of the part of the surface of the box part with which it is intended to cooperate.

By virtue of the invention, the stiffening of the box part is obtained by the combined action of the first contact element and of the second contact element which can tighten between them certain parts of the box part, which immobilizes these parts and ensures a lasting stiffening of the box part. This immobilization can take place independently of the distribution of the supporting means along the box part. The number of stiffening devices can therefore be adapted to the vibrational behaviour of the box part, without increasing its installation time. The propagation of the vibrations in the box part is thus avoided, to a great extent.

According to advantageous but non-mandatory aspects of the invention, such a stiffening device may incorporate one or more of the following characteristics, taken in any technically acceptable combinations:
The device is suitable for creating a rigid link between the free edges of the box part, with no degree of freedom along an axis which is, on the one hand, perpendicular to a longitudinal axis of the box part and, on the other hand, parallel to the bottom of the box part.
The first contact element is in contact only with an external surface of the box part and the second contact element is in contact only with an internal surface of the box part, when the device is mounted tightened on the box part. As a variant, the first and second contact elements cooperate both with a part of the internal surface and a part of the external surface of the box part, when the device is mounted tightened on the box part.
The tightening means act in a direction of convergence of the two contact elements towards one another.
The tightening means comprise a screw, a screw-nut assembly or a pivoting hook.
One of the contact elements comprises a lateral abutment making it possible to form a lateral bearing surface for the other contact element, when mounting and tightening the contact elements and the tightening means.
The first and/or the second contact element is in two parts. In this case, the tightening means advantageously act in a direction of convergence or divergence, one relative to the other, of the two parts of this contact element.
The first element and/or the second element is/are equipped with shims for rigid or elastic contact with the box part. These shims can be dished parts respectively integral with the first contact element and/or the second contact element. Alternatively, these shims can be made by pieces, in particular made of an elastomer, inserted between, on the one hand, ends of the first contact element and/or the second contact element and, on the other hand, the external surface and/or the internal surface of the box part.
The device comprises at least one dynamic vibration absorbing means. In this case, provision can be made for the dynamic vibration absorbing means to comprise a piezoelectric element, suitable for generating an electric voltage under the effect of a deformation or a mechanical stress, connected to an electrical resistance.

The invention also relates to a box part for receiving a motor-drive device for operating a blind, notably a venetian blind, this box part having a U section. This box part is characterized in that it is equipped with at least one device as mentioned above which makes it possible to stiffen it,along an axis perpendicular to a longitudinal axis of the box part.

The invention will be better understood and other advantages of it will become more clearly apparent in light of the following description of three embodiments of a device for stiffening a box part that conform to its principle, given solely as an example and with reference to the drawings in which:

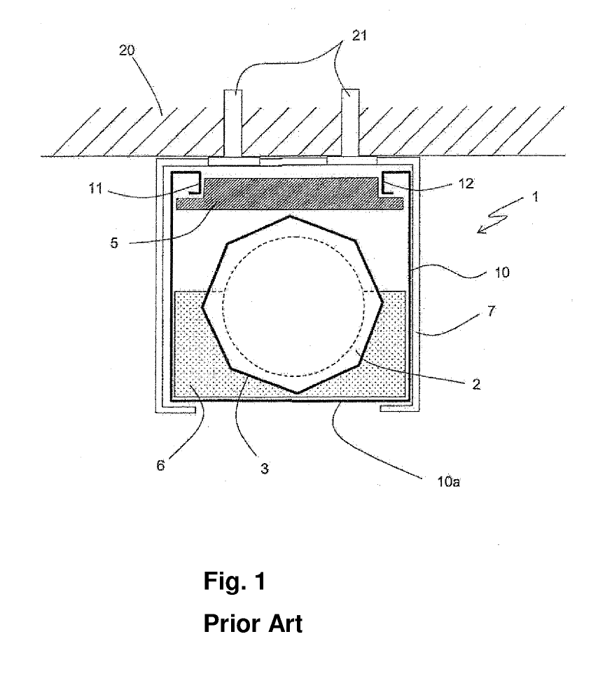

FIG. 1 is a cross-section of a box part equipped with a stiffening device of the prior art;

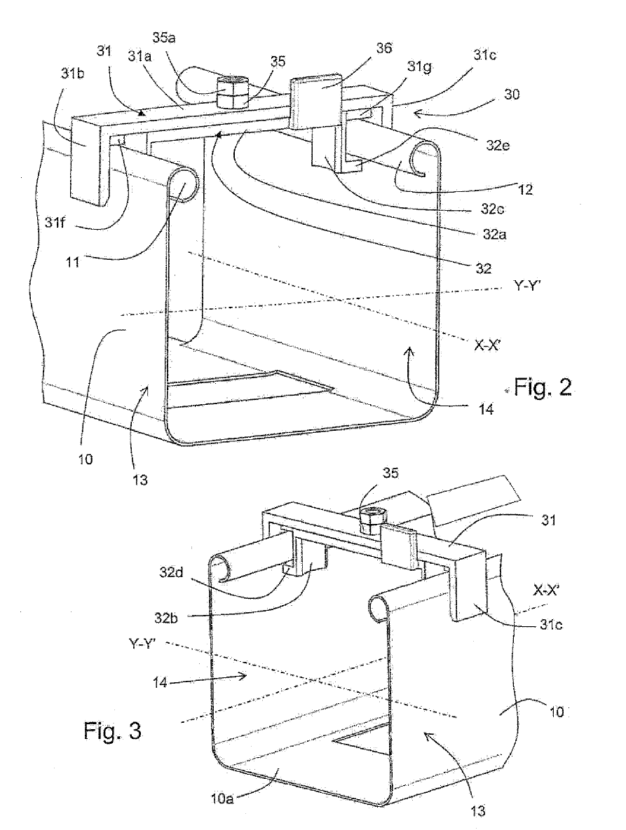

FIGS. 2 and 3 are perspective views of a box part equipped with a stiffening device according to a first embodiment of the invention;

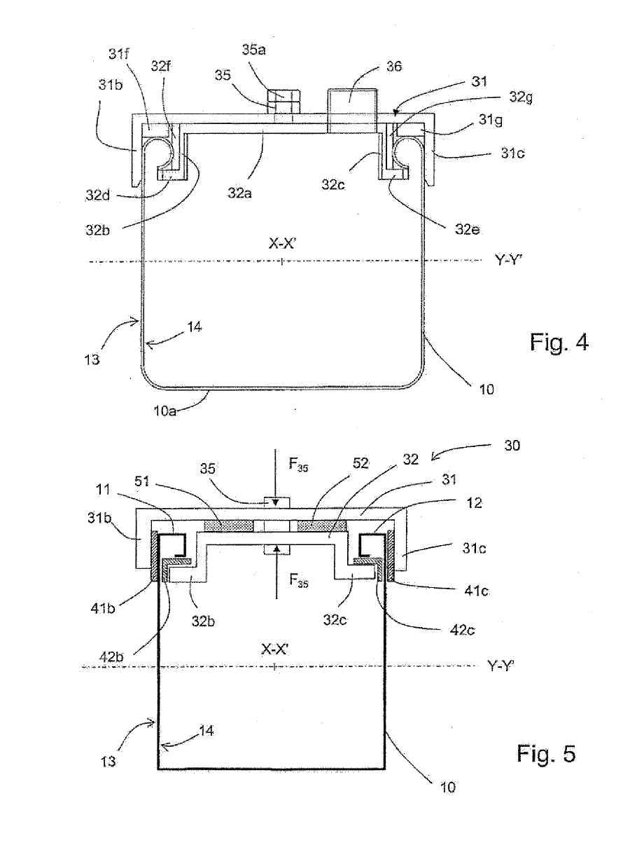

FIG. 4 is an end view of the box part of FIGS. 2 and 3;

FIG. 5 is an end view, comparable to FIG. 4, for a box part and a stiffening device according to a second embodiment of the invention, certain parts being represented shaded, to facilitate their identification; and

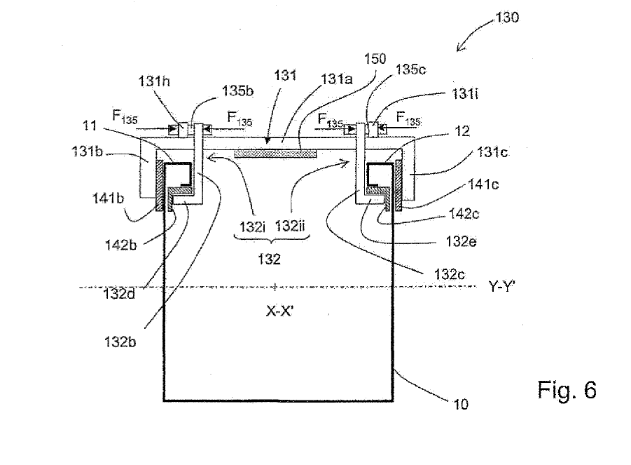

FIG. 6 is a view similar to FIG. 5 for a stiffening device and a box part that conform to a third embodiment of the invention.

FIG. 1 schematically shows a cross-sectional view of a motor-drive device 1, comprising a box part (or rail) 10 in which is placed a motor (not represented) and a winding tube 3, according to the prior art. The box part 10 has a substantially square section forming a U, whose edges 11, 12 are bent back so as to stiffen this section. The motor or the winding tube are held in place by a tightening piece 5, that is housed inside the U section and partly under the bent-back edges 11 and 12. This tightening piece is mainly used to keep the motor and/or the winding tube tightened against the bottom 10a of the box part 10. The conventional tightening means are not represented. An elastomer shim 6 may be present between the box part and the various elements of the motor-drive device (flange, motor, tube). A flange 7, which is in the form of a hook surrounding the box part 10 and is located in a plane different from the cross-sectional plane taken at the level of the tightening part 5, is secured by two fixing elements 21 at the level of a support structure 20, for example a ceiling. This flange participates in the suspension of the device from the ceiling.

FIGS. 2 and 3 show in perspective a first exemplary embodiment, according to the invention, of a device 30 for stiffening a box part 10, the latter being partially represented. FIG. 4 represents this first exemplary embodiment as an end view. For increased simplicity in these various figures, the other elements contained in the box part are not represented. In this first embodiment, the stiffening device is not involved in securing and tightening the motor or the winding tube in the box part, but this alternative can be envisaged. Fixing elements, comparable to those, 21, of FIG. 1, but not represented, are used to immobilize the box part 10 on a support structure, for example a ceiling. These fixing elements cooperate with a flange similar to flange 7 of the prior art and are independent of the device 30.

Thus, for a given box part 10, the fixing elements that are not represented are dedicated to mounting on the support structure and distributed along the rail according to its weight and its environment, for example the nature of the ceiling which may be made of beams and plaster. One or more devices 30 are mounted on the box part 10 in places likely to correspond to vibrational deformation antinodes, that is in zones of deformation of maximum amplitude, e.g. between two consoles for fixing the box part to a support structure. Since the devices 30 are independent of the fixing elements, their number and their positions along the longitudinal axis X-X′ of the box part can be adapted according to the vibrational behaviour of the box part, without increasing the motor-drive device installation time.

In practice, although the impressed curvature at the free edges of the box part makes it possible to stiffen the latter, the longitudinal opening needed to insert the winding tube or the motor necessarily results in a fragility of the box part which lends itself to the propagation of the vibrations deriving from the mechanical transmissions of movement from the motor.

In the description that follows, the elements represented in FIGS. 2 to 4 which are similar to those of FIG. 1 are given the same references.

The stiffening device 30 comprises a first contact element 31 intended to cooperate with at least a part of a surface 13 facing towards the outside of a box part 10, called the external surface, and a second contact element 32 intended to cooperate with at least a part of a surface 14 facing towards the interior of the box part, called the internal surface. The external surface 13 extends, in particular, on the outside of the branches of the U formed by the cross section of the box part 10. The external surface 13 and/or the internal surface 14 are not necessarily continuous, because of the bent-back edges of the box part. The device 30 also comprises tightening means 35 for tightening the first element 31 and the second element 32 relative to one another.

The first contact element is in the form of an external flange 31 comprising a median part 31a and ends 31b and 31c folded back relative to the median part so as to be housed on either side of the box part 10. The external flange 31 is directly in contact with the external surface 13 of the box part, on the vertical walls and/or on a part of the bent-back edges of the box part 11, 12 facing towards the exterior of the box part.

The external flange 31 may be put in place on the box part 10 by elastic deformation in particular of the box part itself. It is preferentially mounted tightened on the box part. The external flange supports, in its median part, a part of the tightening means 35.

The fixing elements that are not represented are added removably to the external flange 31.

The second contact element is in the form of a flange 32 internal to the box part, comprising a median part 32a and ends 32b and 32c that are folded back so as to be housed under the bent-back and free edges 11 and 12 of the box part when the latter is installed. In particular, the folded ends of the internal flange 32 are also themselves bent back towards the outside to form two tabs 32d, 32e for attaching the internal flange under the edges 11 and 12 of the box part 10. The internal flange 32 is directly in contact with the internal surface of the box part, on the vertical walls and/or on a part of the bent-back edges of the box part facing towards the interior of the box part.

The internal flange 32 may be put in place in the box part by lateral displacement, by rotation or by elastic deformation of the box part 10 and/or of the flange 32. The internal flange supports, notably in its median part, a part of the tightening means 35. It is preferentially mounted tightened on the box part.

The flanges 31 and 32 may be made of a plastic material or metal.

The tightening means 35 consist, for example, of a screw and a nut, positioned on either side of the two median parts of the first and second flanges. They allow for the convergence of the two flanges with respect to one another, therefore the tightening of the edges 11 and 12 of the box part 10 between the flange 31 and the tabs 32d and 32c. A lock nut 35a ensures the immobilizing of the means 35 in the tightened configuration.

Alternatively, the flanges can be tightened relative to one another by rotation. In particular, the internal flange may be put in place slantwise to the opening of the box part then rotated, relative to the external flange, so as to tighten its folded ends against the internal surface of the box part. Preferentially, the tightening means then comprise a member for rotating the internal flange and/or an anti-loosening clip, preventing the loosening of the internal flange under the effect of repeated vibrations.

When they are installed facing the box part 10, the convergence of the two flanges 31 and 32 makes it possible to clamp the edges 11 and 12 of the box part and thus create a rigid link between the two bent-back and free edges of the box part. The section of the box part is then closed at the level of the stiffening device 30, with no degree of freedom along an axis Y-Y′ perpendicular to the longitudinal axis X-X′ of the box part and parallel to its bottom 10a. This link makes it possible to stiffen all the box part 10. One or more stiffening devices 30 may be installed over the length of the box part 10, if possible evenly distributed over this length, parallel to the axis X-X′.

It is important for the two edges of the box part to be rigidly secured along the axis Y-Y′. This is because any play would not make it possible to effectively limit the propagation of the sound waves and of the vibrations to the box part and, indirectly, to the elements assembled in the latter for operating the blind.

Shims can be used to adjust the two contact elements relative to one another according to the box parts used. In particular, the external flange 31 comprises two shims 31f and 31g intended to bear, from above, on the edges 11 and 12 of the box part. These shims may be produced integrally with the flange 31 or be added on during assembly and before tightening. Similarly, dished parts 32f and 32g are created at the level of the folded ends of the flange 32 and designed to bear on the part of the edges 11 and 12 facing towards the interior of the box part 10. These shims may be rigid or elastic.

The internal flange 32 also comprises a lateral abutment 36, making it possible to form a lateral bearing surface for the external flange 31, during the assembly and tightening of the elements 31, 32 and 35, and thus correctly position the flanges relative to one another. This lateral abutment could alternatively be positioned on the external flange.

Other possible exemplary embodiments are represented in the following figures.

In the second embodiment represented in FIG. 5, the stiffening device 30 is independent of the elements that are not represented used for fixing the box part 10 to the ceiling or to a wall. The flanges 31 and 32 are respectively in contact with the external 13 and internal 14 surfaces of the box part 10 via elastomer pieces. More specifically, elastomer shims 41b and 41c are inserted between the bent-back ends 31b and 31c of the flange 31 and the surface 13. Moreover, elastomer shims 42b and 42c are inserted between the bent-back ends 32b and 32c of the flange 32 and the surface 14. It will be noted that the shims 42b and 42c have an L section, so that they also extend between the ends 32d and 32c and the bent-back edges 11 and 12 of the box part 10.

The tightening means 35 may be of any type suited to their functions, notably a screw, a screw/nut assembly or a pivoting hook. In FIG. 5, these tightening means are represented by a rectangular element and the two arrows F₃₅ represent the tightening force exerted on the flanges 31 and 32.

FIG. 6 represents a third exemplary embodiment. The references of the preceding figures are reused and increased by 100 to designate similar elements.

In this example, the fixing device is independent of the elements that are not represented for fixing the rail 10 to the ceiling or to a wall. The external flange 131 is formed by a central part 131a and two ends 131b and 131c folded relative to the central part so as to be housed on either side of the box part 10. It also comprises fixed pins 131h and 131i extending from the median part of the external flange opposite its ends 131b and 131c. The internal flange 132 is formed by two independent parts 132i and 132ii. Each part of the internal flange 132 is formed by an arm 132b, 132c whose end 132d, 132e is folded to be housed under the bent-back edges 11 and 12 of the box part. Each part 132i or 132ii of the internal flange 132 can slide relative to the external flange and be held tightened against one of the fixed pins 131h or 131i, as represented by the arrows F₁₃₅.

When the fixing device 130 is mounted relative to the rail 10, the tightened flanges 131 and 132 clamp the bent-back edges of the box part. This clamping may take place by direct contact between the flanges 131 and 132, on the one hand, and the box part 10, on the other hand. As a variant, and as is represented in FIG. 6, this clamping may take place via shims made of elastomer 141b, 142b, 141c, 142c. In all cases, the flanges 131 and 132 form a rigid link with the box part 10, in particular along an axis Y-Y′ defined as in the first embodiment.

The arms of the internal flange 132 and the pins of the external flange 131, namely the arm 132b and the pin 131h on one side, the arm 132c and the pin 131i on the other, are produced so that each presents a tightening surface with respect to the other when these flanges are assembled on the box part 10. The tightening means 135b and 135c may here consist of a screw and a nut, on either side of the two facing surfaces of the two flanges. The tightening provokes the axial displacement, parallel to the axis Y-Y′, of the parts 132i and 132ii of the internal flange 132. This tightening may affect either the two parts 132i and 132ii simultaneously, or one tightening means for each internal flange part. Thus, the flange 132 clamps the bent-back edge of the box part.

An alternative to this third embodiment consists in using a one-part internal flange and a two-part external flange. The mounting is equivalent to that described above.

In a variant of the embodiments represented, the stiffening device may comprise two independent, and preferentially symmetrical, flanges, each forming a contact between an external surface and an internal surface of the box part on either side of the opening of the box part. A tightening means ensures the convergence of the flanges and also the contact with the various surfaces of the box part.

In the embodiments of FIGS. 5 and 6 and in the variant envisaged above, the stiffening device 30 or 130 makes it possible, like that of the first embodiment, to create a rigid link between the free edges 11 and 12 of the box part, with no degree of freedom along the axis Y-Y′. This is obtained by virtue of the closure of the U section of the box part by the stiffening device, in locations chosen along the box part independently of the position of the fixing elements on the support structure.

Advantageously, the stiffening device 30 or 130 comprises at least one dynamic vibration absorbing means as represented, with the references 51, 52 and 150, in FIGS. 5 and 6. This dynamic vibration absorbing means transforms the mechanical energy, of vibrational type, into thermal energy. This dynamic vibration absorbing means comprises, for example, a piezoelectric element, suitable for generating an electrical voltage under the effect of a deformation or a mechanical stress, connected to an electrical resistance. Thus, the electrical energy produced is all dissipated by Joule effect into the electrical resistance. According to a preferred variant, a single compound material, exhibiting both piezoelectric and electrical resistance properties, suitable for simultaneously producing and dissipating the electrical energy from a mechanical vibration energy, is used to produce the dynamic absorbing means.

So as to allow for optimal operation both in compression and in shear mode, the compound material is positioned so as to be stressed in the space contained between the two flanges, as represented in FIG. 5. Alternatively, the dynamic vibration absorbing means is simply glued to one of the flanges, as represented in FIG. 6. It then operates primarily in shear mode.

The vibration absorbing means may operate in a purely passive way, or in an active way as described, for example, in the patents U.S. Pat. No. 6,178,246 or U.S. Pat. No. 6,609,985.

The technical characteristics of the embodiments and of the variants envisaged above may be mutually combined.

1. Device for stiffening a box part for receiving a motor-drive device for operating a blind, the box part having a U section with an external surface and an internal surface, wherein the device is independent of the supporting means for the box part relative to a support structure and wherein it comprises:
a first contact element intended to cooperate with at least a part of the external surface of the box part;
a second contact element intended to cooperate with at least a part of the internal surface of the box part, and
tightening means acting on the first contact element and/or the second contact element, in a direction of convergence of this element and of the part of the surface of the box part with which it is intended to cooperate.

2. Device according to claim 1, wherein the device is suitable for creating a rigid link between the free edges of the box part, with no degree of freedom along an axis which is, on the one hand, perpendicular to a longitudinal axis of the box part and, on the other hand, parallel to the bottom of the box part.

3. Device according to claim 1, wherein the first contact element is in contact only with an external surface of the box part and the second contact element is in contact only with an internal surface of the box part, when the device is mounted tightened on the box part.

4. Device according to claim 1, wherein the first and second contact elements cooperate both with a part of the internal surface and a part of the external surface of the box part, when the device is mounted tightened on the box part.

5. Device according to claim 1, wherein the tightening means act in a direction of convergence of the two contact elements towards one another.

6. Device according to claim 1, wherein the tightening means comprise a screw, a screw-nut assembly or a pivoting hook.

7. Device according to claim 1, wherein one of the contact elements comprises a lateral abutment making it possible to form a lateral bearing surface for the other contact element, when mounting and tightening the contact elements and the tightening means.

8. Device according to claim 1, wherein the first and/or the second contact element is in two parts.

9. Device according to claim 8, wherein the tightening means act in a direction of convergence or divergence, one relative to the other, of the two parts of the contact element in two parts.

10. Device according to claim 1, wherein the first contact element and/or the second contact element is/are equipped with shims for rigid or elastic contact with the box part.

11. Device according to claim 10, wherein the shims are dished parts respectively integral with the first contact element and/or the second contact element.

12. Device according to claim 10, wherein the shims are made by pieces, inserted between, on the one hand, ends of the first contact element and/or the second contact element and, on the other hand, the external surface and/or the internal surface of the box part.

13. Device according to claim 12, wherein the pieces are made of an elastomer.

14. Device according to claim 1, wherein it comprises at least one dynamic vibration absorbing means.

15. Device according to claim 14, wherein the dynamic vibration absorbing means comprises a piezoelectric element, suitable for generating an electric voltage under the effect of a deformation or a mechanical stress, connected to an electrical resistance.

16. Box part for receiving a motor-drive device for operating a blind, notably a venetian blind, this box part having a U section, wherein it is equipped with at least one device according to claim 1, making it possible to stiffen it, along an axis perpendicular to a longitudinal axis of the box part.
